(19) United States
(12) Patent Application Publication
(10) Pub. No.: US 2009/0218208 A1
(43) Pub. Date: Sep. 3, 2009

(54) DISCONNECTOR AND A SUPPORT INSULATOR THEREFOR

(75) Inventor: Urban Astrom, Saxdalen (SE)

Correspondence Address: VENABLE LLP, P.O. BOX 34385, WASHINGTON, DC, 20043-9998, US

(73) Assignee: ABB TECHNOLOGY LTD., Zurich (CH)

(21) Appl. No.: 12/161,372

(22) PCT Filed: Jun. 15, 2006
(86) PCT No.: PCT/SE2006/000715

§ 371 Date: Mar. 30, 2009

Related U.S. Application Data
(60) Provisional application No. 60/759,569, filed on Jan. 18, 2006.

(51) Int. Cl. H01H 33/00

(52) U.S. Cl. 200/48 SB

(57) ABSTRACT

A disconnector for interrupting a current path on a voltage of at least 100 kV with respect to earth. Two groups of elongated post-like support insulators are adapted to rest on the ground and support an end of a conductor each on a high level above the ground. A disconnector arm is connected to one or both of the conductor ends and is moveable for connecting and disconnecting these conductor ends. At least the external parts of the support insulators are made of a hydrophobic rubber composite insulating material.

### TECHNICAL FIELD OF THE INVENTION AND PRIOR ART

The present invention relates to a disconnector for obtaining a physical interruption of a current path being at a high voltage of at least 100 kV with respect to earth, said disconnector comprising two groups of elongated post-like support insulators adapted to rest on the ground and support an end of a conductor included in said current path each on a high level above the ground, in which at least a first of said support insulator groups supports a disconnector arm connected by one end thereof to one of said conductor ends and moveable from a closed position of the disconnector in which the arm by the other free end thereof connects to the other conductor end for disconnecting said conductor ends from each other, as well as a support insulator for such a disconnector.

It is pointed out that “insulating” throughout this disclosure means “electrically insulating” although not explicitly mentioned.

Said high voltage may be an alternating voltage as well as a direct voltage, although the invention is particularly directed to the direct voltage case, since it is especially concerned with problems increasing with the level of said high voltage. The case of a disconnector arranged in connection with a converter station of an HVDC (High Voltage Direct Current) transmission system will therefore be briefly discussed hereinafter for illuminating but not in any way restricting the invention thereto.

When transmitting direct voltage in a direct voltage network connected to such a converter station it is desired to have a voltage being as high as possible, since the transmission losses are reduced when the voltage increases. Thus, it is an ongoing attempt to increase the voltage of the poles of a transmission line of such a transmission system with respect to earth. This does then also mean that the height of a said current path over the ground has to be increased. Disconnectors of this type are normally arranged in a switchyard outside converter valve halls for disconnecting equipment for maintenance thereof or upon failure thereof, for disconnecting a pole of said transmission line upon occurrence of an earth fault thereon and so on.

This means that problems may occur when said high voltage is increased to higher levels, especially in the order of 600 kV and thereabove. In order to obtain a good flash over performance of said support insulators for such a disconnector it has been necessary to give them a height making them both projecting above the rest of the equipment of a switchyard and also sensitive to mechanical stresses associated with very high support insulators and seismics events. Said support insulators are normally made of porcelain and are provided with external radial flanges, sheds, distributed substantially uniformly in the longitudinal direction of the insulator. These are dimensioned for a certain creep distance considering that the disconnector normally is subjected to whether, such as rain, which may prolong said creep distance. Furthermore, each high such support insulators has to be built up of a number of coaxially superimposed support insulator portions interconnected by metallic flanges attached to the insulator further increasing the height of the support insulator.

### SUMMARY OF THE INVENTION

The object of the present invention is to provide a disconnector and a support insulator therefor of the type defined in the introduction making it possible to reduce the height of such support insulators and by that of such a disconnector.

This object is according to the invention obtained by providing such a disconnector, in which at least the external parts of said support insulators are made of a hydrophobic rubber composite insulating material.

By using such a hydrophobic rubber composite insulating material for said support insulator the creep distance of the support insulator can be reduced thanks to the hydrophobic character remarkably reducing the risk of occurrence of any creeping currents on the surface of the insulator during humid conditions, such as rain and fog. This means that the support insulators of the disconnector may be designed to take more kV/mm without an increased risk of flash-overs and other problems. Another advantage of such rubber composite insulating material with respect to the use of porcelain for support insulators is that the manufacturing procedures thereof are such that said radial flanges or sheds when present may be made thinner, which for a certain free space between adjacent such flanges results in more such flanges per length unit also reducing the height of such a support insulator for a determined voltage. The manufacturing also result in a possibility to make support insulators made of this material longer than support insulators made of porcelain, so that the number of said metallic flanges interconnecting two superimposed support insulator portions may be reduced and by that also the height of the support insulator, since each such interconnecting metallic flange adds to that height. Thus, a number of advantages result by this new approach to use a hydrophobic rubber composite insulating material for support insulators in disconnectors for such high voltages. Such or similar composite insulating materials have so far been used to enclose different apparatuses, like breakers, voltage dividers etc.

According to an embodiment of the invention said insulating material comprises rubber embedded in a refractory filler material. The fire retardant property of the filler material is important when handling these high voltages.

According to a another embodiment of the invention the rubber is embedded in a filler material being also corona resistant, which reduces the risk of the occurrence breakdown of the insulating material, such as in the air gap between adjacent such radial flanges of the support insulator.

According to another embodiment of the invention said hydrophobic rubber composite insulating material contains a rubber selected from Si-rubber compounds. Such Si-rubber composite insulating materials have been found to have exactly the properties asked for here.

According to another embodiment of the invention said rubber is embedded in a filler material of aluminium trihydrate, which is a suitable filler for forming a hydrophobic rubber composite insulating material according to the invention.

According to another embodiment of the invention said support insulators are substantially entirely made of said hydrophobic rubber composite insulating material. The post-like support insulator may be manufactured by any known manufacturing process for such a material in one single piece including said radial flanges and possibly modified end portions for connection to other parts.

According to another embodiment of the invention each said support insulator has a plurality of external radial flanges or sheds distributed substantially uniformly in the longitudinal direction of the insulator. Such radial flanges or sheds may thanks to the use of this material be made thinner than would they have been of porcelain, so that a higher number of such sheds may be arranged per length unit for a determined air gap between subsequent such sheds.

According to another embodiment of the invention said support insulator group supporting said disconnector arm has a manoeuvre support insulator adapted to be moved for moving said arm for disconnecting and connecting said two conductor ends, and this manoeuvre support insulator is made of the same material as the other support insulators. This means that the height may be reduced correspondingly for also this manoeuvre support insulator, which of course is of great importance for keeping the height of the disconnector at a reasonable level.

According to another embodiment of the invention the disconnector comprises a stand of steel or a similar material through which said support insulator groups are adapted to rest on the ground. Thus, the disconnector has not to rest on the ground directly through said support insulators, but a stand stabilizing the structure may rest on the ground and support said support insulators.

According to another embodiment of the invention each said support insulator is made of at least two superimposed support insulator portions interconnected by a stabilizing support frame to be coaxially arranged. The stabilizing support frame may be formed by metallic flanges. This may be convenient when the disconnector is constructed for very high voltages, such as above 600 kV and the height of the support insulators will be considerable, such as in the order of 10 metres, and it will therefor not at least be complicated to handle such a long support insulator during transport would it be in one piece.

According to another embodiment of the invention each said support insulator portion is longer than 2.5 metres, preferably longer than 3 metres, advantageously longer than 4 metres or longer than 5 metres. Thanks to the manufacturing procedures and to the high mechanical resistance properties of the material used for said support insulators it is possible to make said support insulator portions that long reducing the number of interconnecting stabilising support frames, such as in the form of metallic flanges, and by that the height of the support insulator.

According to another embodiment of the invention said disconnector is adapted to obtain a physical interruption of a current path being at a voltage of above 200 kV, above 400 kV, above 600 kV, 700-1000 kV or approximately 800 kV with respect to earth. As already mentioned, the higher said voltage the more interesting is the use of support insulators of a hydrophobic rubber composite insulating material according to the invention without for that sake restricting the invention to such very high voltages.

According to another embodiment of the invention the disconnector is adapted to obtain a physical interruption of a current path normally conducting a current of above 500 A, for example 1 kA-5 kA. These are levels of currents normally occurring in current paths to be interrupted by a disconnector where said high voltages prevail.

The invention also relates to a support insulator for a disconnector for obtaining a physical interruption of a current path being at a high voltage of at least 100 kV with respect to earth according to the appended claims directed to such a support insulator, and the advantages thereof and of the different embodiments of such a support insulator according to the invention appear from the description above of the disconnector according to the invention.

The invention also relates to a use of a disconnector according to the invention or a support insulator according to the invention in connection with a converter station of an HVDC (High Voltage Direct Current) transmission system, where a disconnector and a support insulator according to the invention are particularly favourable. The disconnector is then suitably arranged to disconnect and connect converters and/or harmonic filters and/or a pole of a transmission line in connection with a said converter station.

Further advantages as well as advantageous features of the invention will appear from the following description.

### BRIEF DESCRIPTION OF THE DRAWING

With reference to appended drawing below follows a specific description of an embodiment of the present invention cited as an example.

In the drawing:

FIG. 1 is a very schematic view illustrating the general structure of a converter station in an HVDC transmission system where a disconnector according to the invention is suitable to use,

FIG. 2 is a simplified side elevation view of a disconnector according to an embodiment of the invention, and

FIG. 3 is a simplified cross-section view of one of the support insulator groups of the disconnector according to FIG. 2 along III-III.

### DETAILED DESCRIPTION OF AN EMBODIMENT OF THE INVENTION

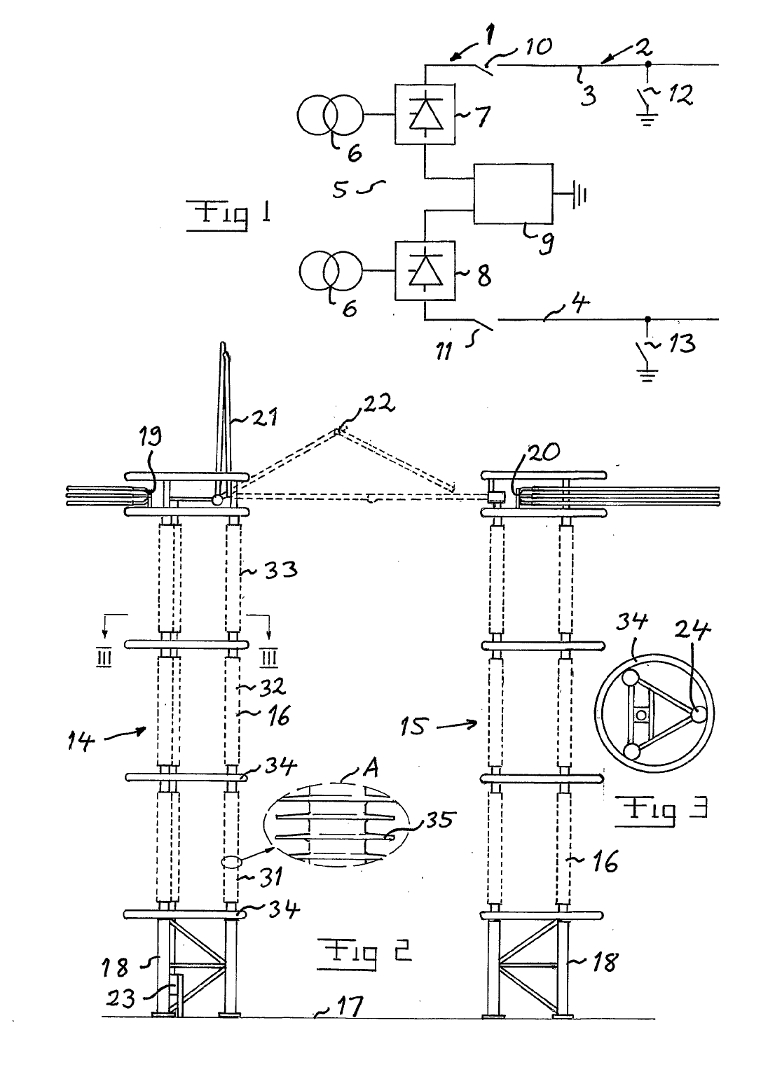

A general design of an HVDC converter station is shown in FIG. 1. A disconnector according to the invention is preferably arranged in connection with such a converter station. This converter station 1 is arranged at one end of an HVDC transmission line 2 having two poles, one 3 with positive and one 4 with negative polarity. An AC-system 5 is connected to the converter station through transformers 6 for obtaining a suitable level of the voltage of said AC-system. The AC-system may be a generating system in the form of any type of power plant with generators of electricity or a consuming system or network connecting to consumers of electric power, such industries and communities. The converter station has two converters 7, 8 having a DC-side thereof connected on one hand to a respective of said two poles 3, 4 and on the other to a DC-neutral arrangement 9 in common to the converters and connecting the low voltage side thereof to earth for defining a certain voltage across each converter. This voltage may typically be in the order of 400 kV-800 kV, in which it is an attempt to increase this voltage as much as possible for reducing the transmission losses in the line 2 as explained above. This converter station has a number of disconnectors adapted to disconnect and connect converters, harmonic filters (not shown), the respective pole of the transmission line and so on. Some such disconnectors 10-13 have been shown just to exemplify this while leaving further equipment well known to those skilled in the art out for simplifying the figure.

An embodiment of such a disconnector will now be explained while making reference to FIGS. 2 and 3. Thus, such a disconnector is designed to obtain a physical interruption of a current path being at a high voltage with respect to earth, and the disconnector shown in FIGS. 2 and 3 is designed for being able to interrupt a current path being at a voltage of 800 kV and which may conduct a current of 4 kA.

The disconnector has two groups with one or more 14, 15 elongated post-like support insulators 16 adapted to rest on the ground 17, here through resting on a stabilising stand of steel, and support an end 19, 20 each of a conductor (bus) included in a said current path on a high level above the ground. The conductor is here formed by three cables connected in parallel with each other. The level is in the present case approximately 13 metres. A first 14 of said support insulator groups carries a disconnector arm 21 provided with a mid-hinge 22 and which may be pivoted between a position in which it closes said current path (dashed lines) and a position in which it interrupts said current path (solid lines). A motor 23 is arranged at the stand 18 of the support insulator group 14 for controlling this connecting and disconnecting operation by acting upon a manoeuvre support insulator 24 having a similar appearance as the two support insulators 16 of the group 14. The support insulator group 15 consists of three support insulators in this example.

Each support insulator is divided into three support insulator portions 31-33 each having a length of 3.3 metres and interconnected by metallic flanges and a stabilizing support frame 34. Each metallic flange has a height in the order of 200 mm.

It is illustrated through an enlargement A that the support insulators have a plurality of radial flanges or sheds 35 uniformly distributed in the longitudinal direction of the insulator for reducing the risk of occurrence of creep currents. The voltage with respect to ground will be shared by the air gaps so formed between subsequent such radial sheds 35.

The support insulators are made of a hydrophobic Si-rubber composite insulating material formed by embedding Si-rubber in a filler of aluminium trihydrate being fire retardant as well as corona resistant. Thanks to the hydrophobic character of this material, the risk of creeping currents under humid conditions, such as rain, will be considerably reduced with respect to porcelain as insulating material, so that the creep distance or leakage path will be reduced and by that more kV/mm may be taken by such a support insulator in the longitudinal direction thereof. This means that the height of such a support insulator may be reduced. The possibility to make the radial flanges 35 thinner makes it possible to reduce the height of the support insulator by a further 10-25%, so that the height thereof may in the present case be about 10 metres plus stand 2.5 metres instead of about 15 metres plus stand, which would be hard to accept, especially in a region with a high seismic activity.

Furthermore, known porcelain support insulators have to be manufactured in portions with a length about 2 metres requiring a metallic flange every 2 metres adding to the height thereof, whereas in the present case said hydrophobic rubber composite insulating material provides a sufficient mechanical stability also for support insulator portions being much longer, such as 5 metres or more would that be desired.

The invention is of course not in any way restricted to the embodiment described above, but many possibilities to modifications thereof would be apparent to a person with ordinary skill in the art without departing from the basic idea of the invention as defined in the appended claims.

The number of support insulators in each of said groups of the disconnector may of course be different than shown in the figures. The construction of the disconnector arm and the way of controlling the movement thereof have nothing to do with the present invention and may be carried out in many other ways than shown.

As already pointed out the disconnector according to the invention may also be used for disconnecting alternating voltage current paths, although the invention is particularly applicable to direct voltage applications where mostly higher voltages occur.

It is pointed out that both support insulator groups may support a disconnector arm, and the two disconnector arms may then in the closed state connect to a contact member located between said conductor ends. “The arm by the other free end thereof connects to the other conductor end” in the claims is to be interpreted to also cover such a case of indirect connection.

1. A disconnector for obtaining a physical interruption of a current path being at a high voltage of at least 100 kV with respect to earth, the current path comprising a plurality of conductors each on a high level above the ground, said disconnector comprising
two groups of a plurality of elongated post-like support insulators adapted to rest on a ground surface and support an end one of the plurality of conductors included in said current path, and
a disconnector arm supported by at least a first of said support insulator groups, the disconnector arm being connected by one end thereof to an end of a first one of said conductors, each disconnector being moveable from a closed position in which the disconnector arm by a second free end thereof connects to an end of a second of the conductors for disconnecting said ends of said first conductor and said second conductor from each other, wherein at least external parts of said support insulators comprise a hydrophobic rubber composite insulating material.

2. The disconnector according to claim 1, wherein said insulating material comprises rubber embedded in a refractory filler material.

3. The disconnector according to claim 2, wherein the rubber is embedded in a corona resistant filler material.

4. The disconnector according to claim 1, wherein said hydrophobic rubber composite insulating material comprises a rubber selected from Si-rubber compounds.

5. The disconnector according to claim 1, wherein said rubber is embedded in a filler material comprising aluminium trihydrate.

6. The disconnector according to claim 1, wherein said support insulators are substantially entirely made of said hydrophobic rubber composite insulating material.

7. The disconnector according to claim 1, wherein each said support insulator comprises a plurality of external radial flanges or sheds distributed substantially uniformly in the longitudinal direction of the insulator.

8. The disconnector according to claim 1, wherein said support insulator group supporting said disconnector arm comprises a manoeuvre support insulator adapted to be moved for moving said arm for disconnecting and connecting said two conductor ends, and wherein the manoeuvre support insulator comprises a same material as the support insulators.

9. The disconnector according to claim 1, further comprising:
a stand through which said support insulator groups are adapted to rest on the ground surface.

10. The disconnector according to claim 1, wherein each support insulator comprises at least two superimposed support insulator portions, the disconnector further comprising:
a stabilising support frame interconnecting and coaxially arranged with respect to the at least two superimposes support insulator portions.

11. The disconnector according to claim 10, wherein each said support insulator portion is longer than 2.5 metres.

12. The disconnector according to claim 1, wherein the disconnector is adapted to obtain a physical interruption of a current path being at a voltage of above 200 kV with respect to earth.

13. The disconnector according to claim 1, wherein the disconnector is adapted to obtain a physical interruption of a current path normally conducting a current of above 500 A.

14. The support insulator for a disconnector for obtaining a physical interruption of a current path being at a high voltage of at least 100 kV with respect to earth, the support insulator comprising:
a hydrophobic rubber composite insulating material.

15. The support insulator according to claim 14, wherein said insulating material comprises rubber embedded in a refractory filler material

16. The support insulator according to claim 15, wherein the rubber is embedded in a corona resistant filler material.

17. The support insulator according to claim 14, wherein said hydrophobic rubber composite insulating material comprises a rubber selected from Si-rubber compounds.

18. The support insulator according to claim 14, wherein said rubber is embedded in a filler material of aluminium trihydrate.

19. A method for high voltage direct current transmission, comprising:
providing a converter station comprising a disconnector
comprising two groups of a plurality of elongated post-like support insulators adapted to rest on a ground surface and support an end one of the plurality of conductors included in a current path, and
a disconnector arm supported by at least a first of said support insulator groups, the disconnector arm being connected by one end thereof to an end of a first one of said conductors, each disconnector being moveable from a closed position in which the disconnector arm by a second free end thereof connects to an end of a second of the conductors for disconnecting said ends of said first conductor and said second conductor from each other, wherein at least external parts of said support insulators comprise a hydrophobic rubber composite insulating material.

20. The method according to claim 19, further comprising:
disconnecting and connecting with the disconnector converters and/or harmonic filters and/or a pole of a transmission line in connection with a converter station.
